(19) United States
(12) Patent Application Publication
(10) Pub. No.: US 2014/0237471 A1
(43) Pub. Date: Aug. 21, 2014

(54) Boot and Browse Apparatus Coupled to Backup Archive and Method of Operation

(71) Applicant: BARRACUDA NETWORKS, INC., CAMPBELL, CA (US)

(72) Inventor: LINDSAY SNIDER, ANN ARBOR, MI (US)

(73) Assignee: BARRACUDA NETWORKS, INC., CAMPBELL, CA (US)

(21) Appl. No.: 14/018,230

(22) Filed: Sep. 4, 2013

Related U.S. Application Data
(60) Provisional application No. 61/767,739, filed on Feb. 21, 2013.

(51) Int. Cl. G06F 9/455

(52) U.S. Cl. CPC G06F 9/45533
USPC 718/1

(57) ABSTRACT

A system enables booting a virtual machine and browsing files from a de-duplicated backup server by initializing a virtual machine process, and setting up NFS services connecting the NFS service to a fake disk. The fake disk is actualized by a backup server and an overlay store. Writing into the fake disk is supported by an overlay store. Reading from the fake disk is supported by file reads from the backup server or from the overlay store.

### RELATED APPLICATIONS

This application claims the priority benefit of U.S. Provisional Application Ser. No. 61/767739 entitled “Boot and Browse Apparatus Coupled to Backup Archive and Method of Operation”, filed Feb. 21, 2013 which is incorporated in its entirety by reference.

### BACKGROUND OF THE INVENTION

The present patent application is presented to solve the long standing and prohibitively costly problem of lengthy recovery of disk images before booting or browsing of backup files. Because conventional disk restore and recovery solutions did not, could not, and would not enable access to selected files before full restoration of disk image which typically requires more than 2 hours of wall clock time, it can be appreciated that particularly for virtual machines, an apparatus enabling quicker booting from or browsing of the content of a backup archive system is eagerly needed.

A conventional system for virtual machine restoration is illustrated in FIG. 2. This system 200 typically has a virtual machine host 290 coupled to a conventional backup system 210. The virtual machine host has an API interface 220 which connects to the backup system and enables reading and creating a bootable disk image 230. When the entire bootable disk image is available, typically, two hours after beginning, a virtual machine 240 initiates an operating system load also known as booting its operating system.

What is needed is a faster and more convenient recovery solution to enable testing, emergency operation, and recovery from outage at a different location. What is desired is a way to operate a network file system circuit 270 within a virtual machine host which allows a virtual machine 280 to boot off a remote compact data store with low latency.

### SUMMARY OF THE INVENTION

An apparatus has a de-duplicated data part store having a plurality of virtual machine parts backed up from a plurality of virtual machines. A file translation layer apparatus presents a bootable pseudo-disk to a network file system apparatus. However the entire bootable pseudo-disk is not entirely elaborated. As portions of the figment are required during a boot sequence, they are assembled from de-duplicated data part store as needed.

### BRIEF DESCRIPTION OF DRAWINGS

The present invention will be understood more fully from the detailed description given below and from the accompanying drawings of various embodiments of the invention, which, however, should not be taken to limit the invention to the specific embodiments, but are for explanation and understanding only.

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an exemplary computer system.

FIG. 2 is a block diagram of a conventional backup system. FIGS. 3-5 are block diagrams of a boot and browse apparatus with data flows.

### DETAILED DISCLOSURE OF EMBODIMENTS

One aspect of the invention is an apparatus which has a processor and non-transitory computer readable media which is communicatively coupled to all of the following components: a backup server coupled to a first network file system circuit, a second network file system circuit coupled by an API to a virtual machine, an overlay store to receive writes operations from the virtual machine.

A method of operation is provided by instructions encoded in non-transitory computer readable media which when executed by the processor provide a bootable pseudo-disk just-in-time figment which contains the desired parts of de-duplicated data part store needed at any point in the boot or browse operation.

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

In the following description, numerous details are set forth. It wall be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the descriptions, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer systems registers and memories into other data similarly represented as physical quantities within the computer system memories or registers or other such non-transitory information storage, communication circuits for transmitting or receiving, or display devices.

The present invention also relates to apparatus for performing the operations herein. This apparatus may be specifically constructed for the required purposes, or it may comprise application specific integrated circuits which are mask programmable or field programmable, or it may comprise a general purpose processor device selectively activated or reconfigured by a computer program comprising executable instructions and data stored in the computer. Such a computer program may be stored in a non-transitory computer readable storage medium, such as, but not limited to, any type of disk including floppy disks, optical disks, CD-ROMs, magnetic-optical disks, solid state disks, flash memory, read-only memories (ROMs), random access memories (RAMs), EPROMS, EEPROMS, magnetic or optical cards, or any type of non-transitory media suitable for storing electronic instructions, and each coupled to a computer system data communication network.

The algorithms and displays presented herein are not inherently related to any particular computer, circuit, or other apparatus. Various configurable circuits and general purpose systems may be used with programs in accordance with the teachings herein, or it may prove convenient to construct more specialized apparatus to perform the required method steps in one or many processors. The required structure for a variety of these systems will be appear from the description below. In addition, the present invention is not described with reference to any particular programming language or operating system environment. It will be appreciated that a variety of programming languages, operating systems, circuits, and virtual machines may be used to implement the teachings of the invention as described herein.

Referring to FIG. 3, a network file system circuit 870 establishes communication with another network file system circuit 270 over a wide area network. A request is received for a system recovery and initialization for a certain configuration. A file system translation layer 830 determines those de-duplicated data parts required to fulfill the initial request, retrieves them from data part store 810 and enables the virtual machine host 290 to boot from a figment of a pseudo-disk 840. Either in response or in anticipation of the next data parts required by the virtual machine host 190, the file system translation layer 830 retrieves and integrates de-duplicated data parts.

Referring now to FIG. 4, the apparatus further has an area of storage referred to as an overlay store 880. File writes during the booting of a system are captured there. The contents of the overlay store are eventually de-dupped and stored into data part store.

Referring now to FIG. 5, the apparatus also provides a browser server 890 coupled to the file system translation layer. Without rebuilding the entire disk image, any part or parts of the disk image may be examined. The file system translation layer determines the version and configuration of the desired operating system and retrieves the desired file parts from the data part store and enables display in a web browser 282.

One aspect of the invention is an apparatus comprising a processor communicatively coupled to all of the following components: a backup server coupled to a first network file system circuit, a second network file system circuit coupled by an API to a virtual machine, an overlay store to receive writes operations from the virtual machine.

Another aspect of the invention is a method for operating the above apparatus comprising steps/processes initializing a virtual machine process through an API, setting up an NFS service to enable booting the virtual machine, connecting the NFS service to a fake disk, provisioning the fake disk from a backup server and overlay store, transferring requested system file reads from the backup server, receiving system file writes in overlay store, enabling a file browser to search the fake disk and provisioning deduped file segments from the backup server store, storing overlay store into dedup store when idle.

Thus, effectively, a fake disk is provided by File System in Userspace coupled to the Backup server.

In an embodiment, an apparatus includes a deduplicated file store; coupled to an overlay store (not de-duplicated) which receives data objects written during a boot process; a Network File System emulator circuit coupled to a Wide Area Network, the overlay store, and the deduplicated file store.

In an embodiment, a pseudo-disk is coupled to a virtual machine and to the Wide Area Network, the pseudo-disk comprising a FUSE executable program encoded on tangible computer readable media coupled to a processor, which the processor reads from and writes to during a boot process.

The FUSE method, known in the art, presents a virtual file system to a virtual machine. Initially Read operations are fulfilled by the dedup store. Write operations are fulfilled into the Overlay store. Further Read operations are fulfilled by either the Overlay store or the dedupe store.

In an embodiment, an API is used only to setup a VM process and to map its disk to a Network File Store provisioned by a Backup Store.

As is known to those skilled in the art, a virtual disk file, which stores the contents of the virtual machine's hard disk drive, is an open standard referred to as VMDK. A virtual disk is made up of one or more .vmdk files. The number of .vmdk files depends on the size of the virtual disk. As data is added to a virtual disk, the .vmdk files grow in size, to a maximum of 2 GB each. Almost all of a .vmdk file's content is the virtual machine's data, with a small portion allotted to virtual machine overhead.

If the virtual machine is connected directly to a physical disk, rather than to a virtual disk, the (dot) vmdk file stores information about the partitions the virtual machine is allowed to access. In an embodiment, the invention enables one to browse o de-duped VMDK from the box de-duping the data. In this setup, NFS isn't involved. One aspect of the invention is a system for browsing a de-duped data store having the following all communicatively coupled: a de-duped VMDK format file in a data store; a backup server coupled to a virtual machine, and an overlay store to receive writes operations from the virtual machine; a file system translation circuit; a random access memory configured as a bootable pseudo-disk; and a browser server.

Another aspect of the invention is a method for browsing a de-duped VMDK formatted file in a data store by receiving a request for data parts in a Virtual Disk from a browser server; operating a file system translation circuit; determining de-duplicated data parts required to fulfill said request; retrieving de-duplicated data parts as determined from a data part store; determining a version and configuration of a desired operating system; retrieving desired file parts from the data part store; and enabling display of file parts in a web browser.

### CONCLUSION

The present invention is easily distinguished from conventional backup, boot, and restore solutions by its speed of operation because the entire disk image is not recovered before execution. This provides a measured savings of more than 2 hours.

Advantageously, many virtual machines may be easily and quickly booted from a single backup apparatus according to the above invention.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

An Exemplary Computer System

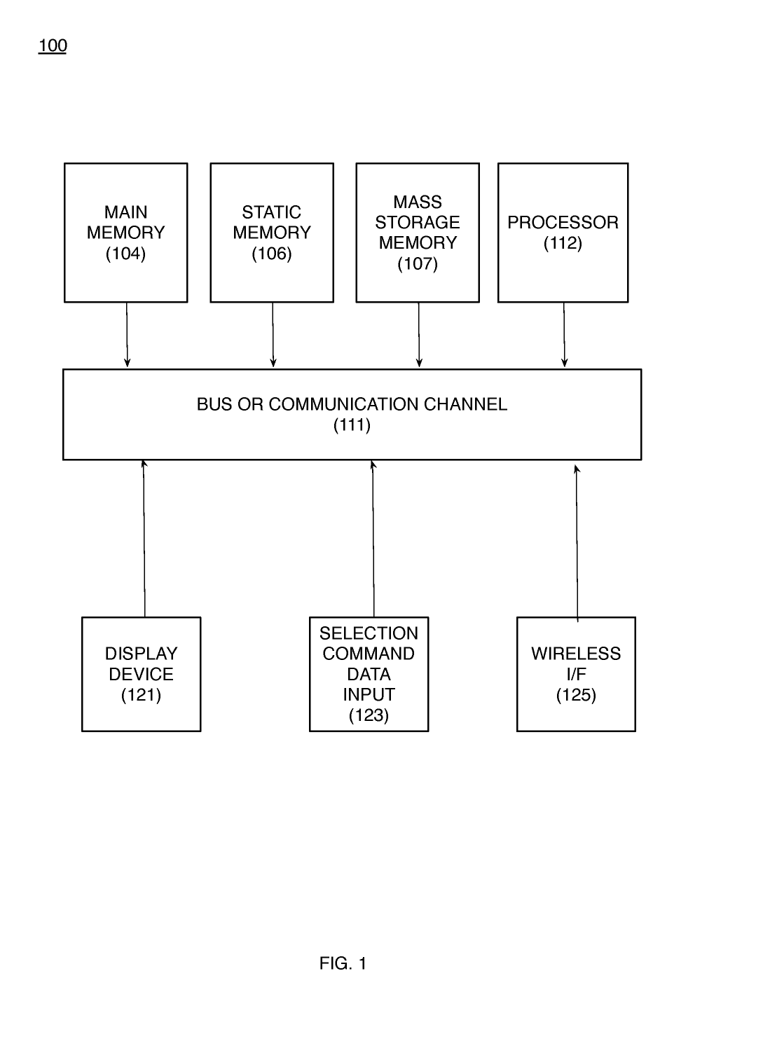

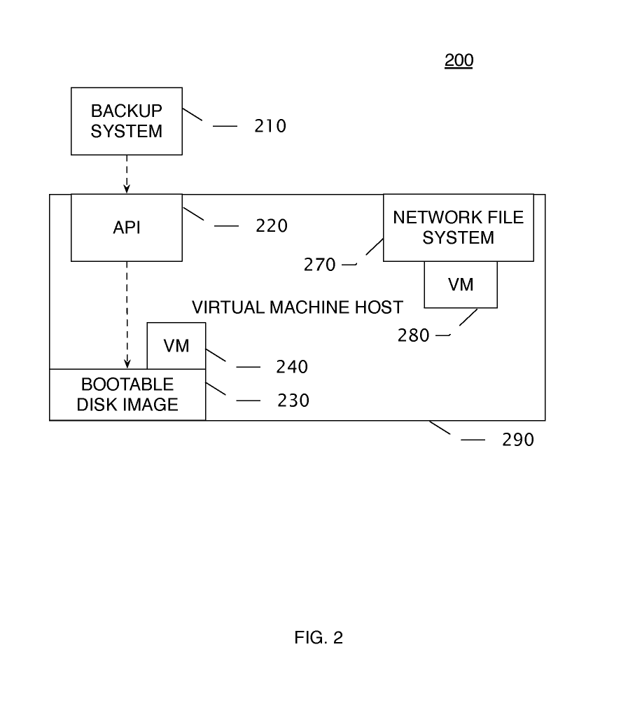

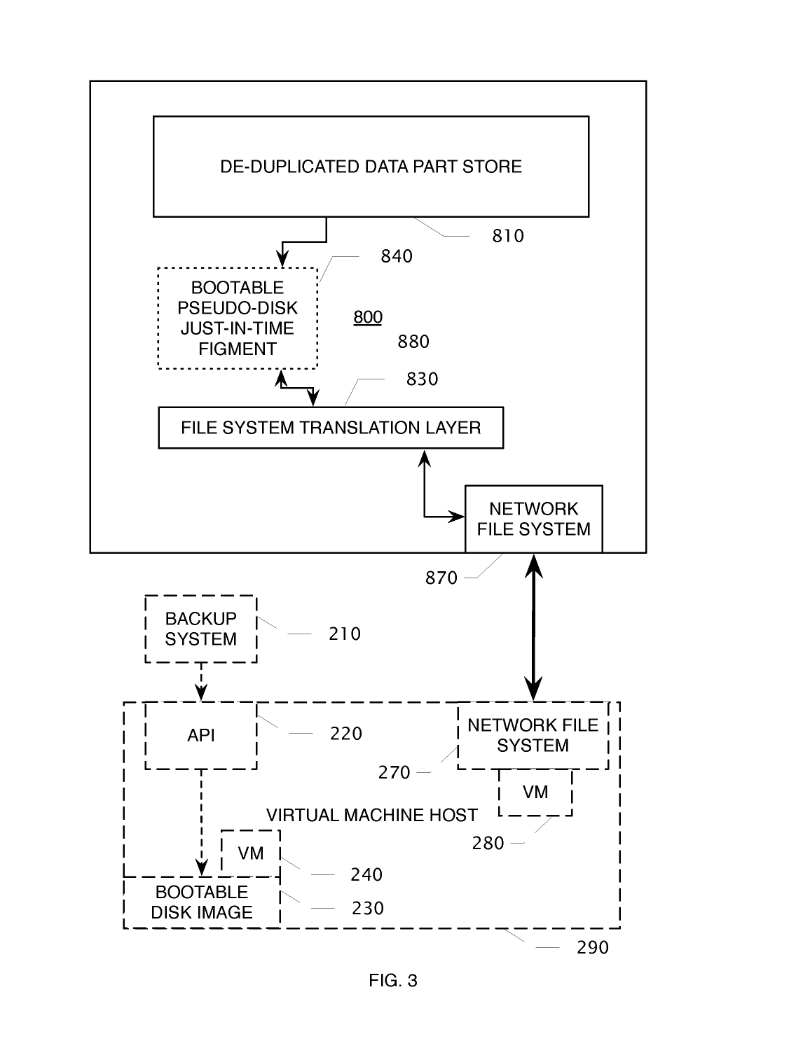

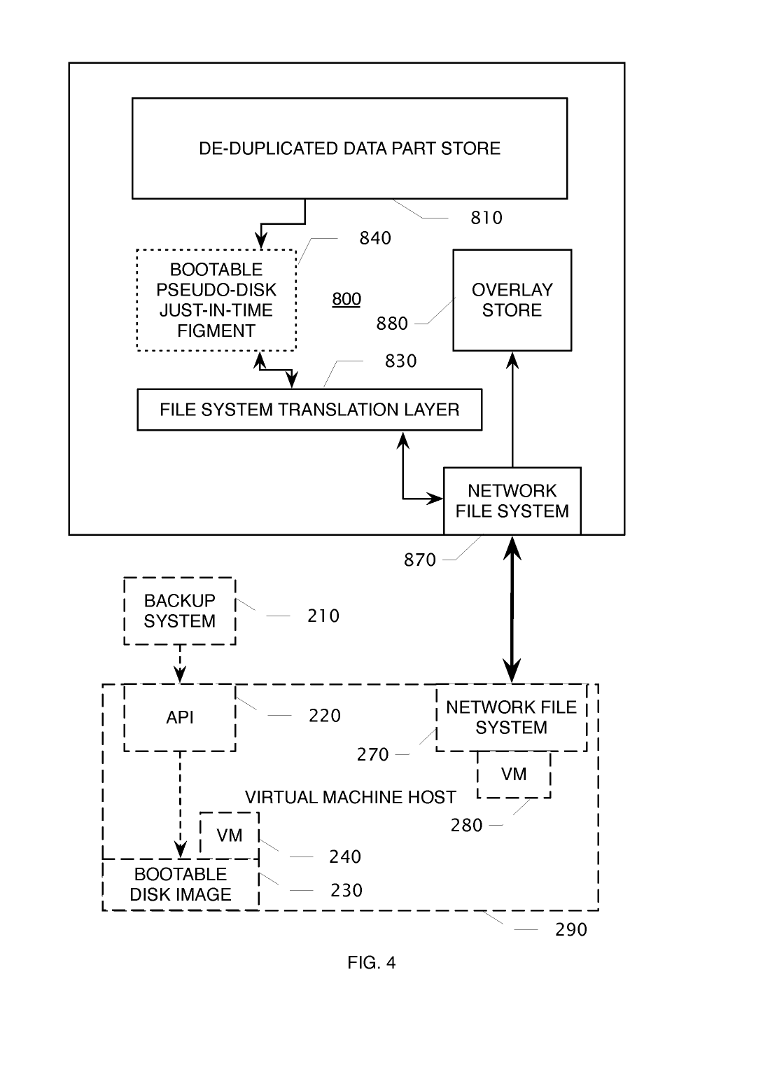

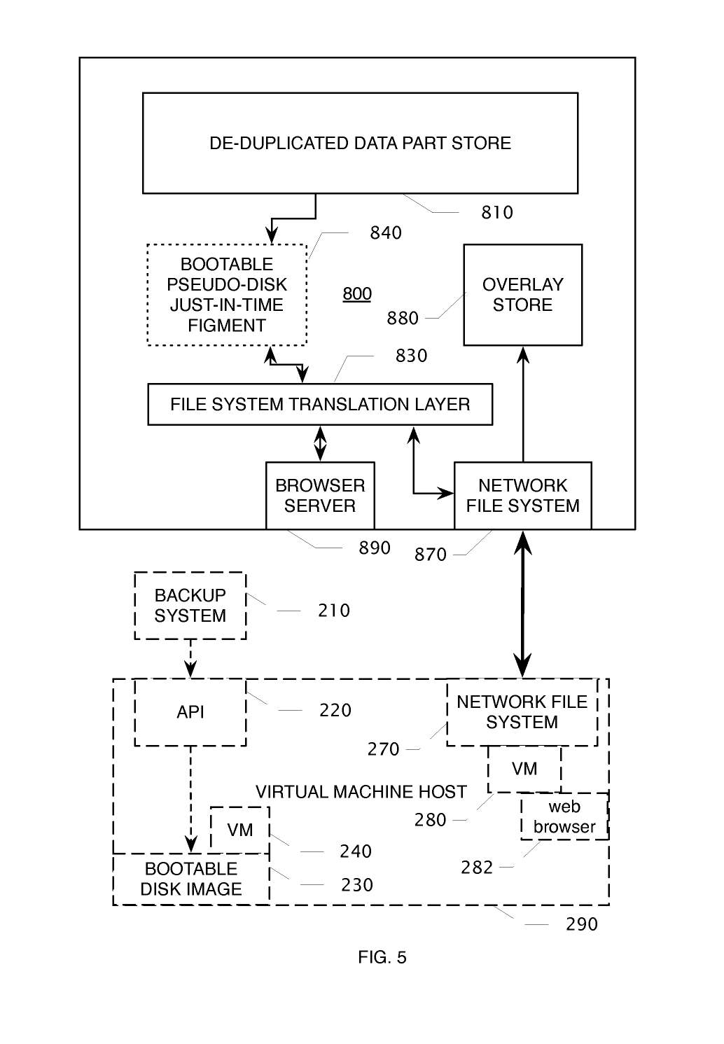

FIG. 1 is a block diagram of an exemplary computer system that may be used to perform one or more of the functions described herein. Referring to FIG. 1, computer system 100 may comprise an exemplary client 150 or server 100 computer system. Computer system 100 comprises a communication mechanism or bus 111 for communicating information, and a processor 112 coupled with bus 111 for processing information. Processor 112 includes a microprocessor, but is not limited to a microprocessor, such as for example, ARM™, Pentium™, etc.

System 100 further comprises a random access memory (RAM), or other dynamic storage device 104 (referred to as main memory) coupled to bus 111 for storing information and instructions to be executed by processor 112. Main memory 104 also may be used for storing temporary variables or other intermediate information during execution of instructions by processor 112.

Computer system 100 also comprises a read only memory (ROM) and/or other static storage device 106 coupled to bus 111 for storing static information and instructions for processor 112, and a non-transitory data storage device 107, such as a magnetic storage device or flash memory and its corresponding control circuits. Data storage device 107 is coupled to bus 111 for storing information and instructions.

Computer system 100 may further be coupled to a display device 121 such a flat panel display, coupled to bus 111 for displaying information to a computer user. Voice recognition, optical sensor, motion sensor, microphone, keyboard, touch screen input, and pointing devices may be attached to bus 111 or a wireless network for communicating selections and command and data input to processor 112.

Note that any or all of the components of system 100 and associated hardware may be used in the present invention. However, it can be appreciated that other configurations of the computer system may include some or all of the devices in one apparatus, a network, or a distributed cloud of processors.

A number of embodiments of the invention have been described. Nevertheless, it will be understood that various modifications may be made without departing from the spirit and scope of the invention. For example, other network topologies may be used. Accordingly, other embodiments are within the scope of the following claims.

What is claimed is:

1. A processor communicatively coupled to all of the following components: a backup server coupled to a first network file system circuit, a second network file system circuit coupled by an API to a virtual machine, and an overlay store to receive writes operations from the virtual machine.

2. The apparatus of claim 1 further comprising:
a file system translation circuit;
a random access memory configured as a bootable pseudo-disk; and
a browser server.

3. A method for operation of a boot and browse apparatus comprising:
establishing a communication channel between a first network file system circuit and a second network file system circuit over a wide area network;
receiving a request for a system recovery and initialization for a certain configuration;
operating a file system translation circuit;
determining de-duplicated data parts required to fulfill said request;
retrieving de-duplicated data parts as determined from a data part store; and
enabling a virtual machine host to boot from said retrieved de-duplicated data parts.

4. The method of claim 3 further comprising:
retrieving next data parts required by the virtual machine host;
integrating de-duplicated data parts; and
fulfilling subsequent requests from the virtual machine host.

5. The method of claim 3 further comprising:
receiving a file write during a booting of a system;
storing file write data to an overlay store; and
reading from overlay store when booting of the system requires data written during the booting of the system.

6. The method of claim 3 further comprising:
receiving a request from a browser server;
determining a version and configuration of a desired operating system;
retrieving desired file parts from the data part store; and
enabling display of file parts in a web browser.

7. A system for rapid virtual machine initialization comprising:
a deduplicated file store; coupled to
an overlay store which receives data objects written during a boot process;
a Network File System emulator circuit coupled to a Wide Area Network, the overlay store, and the deduplicated file store;
a pseudo-disk coupled to a virtual machine and to the Wide Area Network, the pseudo-disk comprising a FUSE executable program encoded on tangible computer readable media coupled to a processor, which the processor reads from and writes to during a boot process, wherein the FUSE program presents a virtual file system to a virtual machine, whereby, initially Read operations are fulfilled by the dedup store, write operations are fulfilled into the Overlay store, and subsequent Read operations are fulfilled by either the Overlay store or the dedup store; and
a processor with stored instruction which when executed provide an API to setup a VM process and to map a disk to a Network File Store provisioned by a Backup Store.

8. A system for browsing a de-duped data store comprising:
a de-duped VMDK format file in a data store;
a backup server coupled to a virtual machine, and an overlay store to receive writes operations from the virtual machine;
a file system translation circuit;
a random access memory configured as a bootable pseudo-disk; and
a browser server.

9. A method for browsing a de-duped VMDK formatted file in a data store comprising:
receiving a request for data parts in a Virtual Disk from a browser server;
operating a file system translation circuit;
determining de-duplicated data parts required to fulfill said request;
retrieving de-duplicated data parts as determined from a data part store;
determining a version and configuration of a desired operating system;
retrieving desired file parts from the data part store; and
enabling display of file parts in a web browser.
